(19) United States
(12) Patent Application Publication
(10) Pub. No.: US 2014/0185688 A1
(43) Pub. Date: Jul. 3, 2014

(54) CODING SYSTEM TRANSFORM APPARATUS, CODING SYSTEM TRANSFORM METHOD, AND STORAGE MEDIUM

(71) Applicant: CANON KABUSHIKI KAISHA, Tokyo (JP)

(72) Inventor: Makoto Kimura, Kawasaki-shi (JP)

(73) Assignee: CANON KABUSHIKI KAISHA, Tokyo (JP)

(21) Appl. No.: 14/141,319

(22) Filed: Dec. 26, 2013

(30) Foreign Application Priority Data
Dec. 28, 2012 (JP) 2012-287235

(51) Int. Cl. H04N 19/61

(52) U.S. Cl. CPC H04N 19/00793
USPC 375/240.18

(57) ABSTRACT

A coding system transform apparatus includes a decoding unit configured to decode a first coded stream coded by a first coding system using a first coding parameter to acquire a decoded image, a coding unit configured to code the decoded image acquired by the decoding unit by a second coding system using a second coding parameter, and a parameter determination unit configured to determine the second coding parameter based on the first coding parameter, wherein the parameter determination unit includes a first size determination unit configured to determine a maximum block size of a second coding block size included in the second coding parameter among a plurality of coding block sizes possible in the second coding system to be a block size that is the same as a first coding block size included in the first coding parameter.

### BACKGROUND OF THE INVENTION

1. Field of the Invention

The present invention relates to a coding system transform apparatus, a coding system transform method, and a storage medium that stores a coding system transform program for transforming a coding system by decoding a moving image coded by a first coding system and recoding the decoded moving image by a second coding system.

2. Description of the Related Art

In recent years, there has been an increasing demand for a transcoding function which recodes a moving image coded by a coding system such as Moving Picture Experts Group (MPEG)-2 and H.264/MPEG-4 Advanced Video Coding (AVC) (hereinafter referred to as H.264) by another coding system. A processing load of the transcoding for transforming a coding system increases because the transcoding requires both the decoding and the recoding processing of the moving image.

Japanese Patent Application Laid-Open No. 2009-111718 discusses a method for decreasing a processing load of a determination processing of an intra prediction block size at the time of recoding and motion search processing while suppressing image degradation in transcoding from MPEG-2 to H.264.

In a joint collaborative team on video coding (JCT-VC), the standardization of a high efficiency video coding (hereinafter referred to as HEVC) that is a next-generation coding system has been promoted at present.

In the HEVC, the size of a coding block (coding unit (CU)) (hereinafter referred to as a CU size) that is a unit of a block for performing coding is variable. In the HEVC, the CU size can take a block size of 64×64 pixels to 8×8 pixels (any of 64×64 pixels, 32×32 pixels, 16×16 pixels, and 8×8 pixels). The size of a prediction block (prediction unit (PU)) (hereinafter referred to as a PU size) that is a unit of a block for performing intra prediction and inter prediction is also variable. In the HEVC, the Intra PU size can take a block size of 64×64 pixels to 4×4 pixels (any of 64×64 pixels, 32×32 pixels, 16×16 pixels, 8×8 pixels, and 4×4 pixels). Furthermore, the size of transform block (transform unit (TU)) (hereinafter referred to as a TU size) that is a unit of a block for performing orthogonal transform is also variable. In the HEVC, the TU size may take a block size of 32×32 pixels to 4×4 pixels (any of 32×32 pixels, 16×16 pixels, 8×8 pixels, and 4×4 pixels).

For this reason, appropriately determining the sizes of the CU, PU, and TU at the time of coding allows a coding efficiency to be improved. The 16×16 pixels represent a block of 16 pixels in the horizontal direction and 16 pixels in the vertical direction. In the present exemplary embodiment, that is denoted as 16×16 pixels. The same holds true for change in the number of pixels.

In existing coding systems excluding the HEVC, the size of a coding block (a coding block size) is fixed. In the MPEG-2 and the H.264, for example, the size of a macro block (MB) (i.e., a coding block) is only 16×16 pixels. In a technique discussed in Japanese Patent Application Laid-Open No. 2009-111718, it is premised that the coding block size is equal before and behind the transcoding. In other words, it is unnecessary for a conventional transcoding (transcoding between the existing coding systems excluding the HEVC) to determine the coding block size after the coding system is transformed.

In the conventional transcoding, the transcoding is performed from the MPEG-2 to the H.264, the coding block size of the MPEG-2 and the H.264 is fixed to 16×16 pixels. For this reason, the conventional transcoding does not require processing for searching a block size best suited for determining the coding block size in the H.264 after the coding system is transformed. More specifically, the conventional transcoding has only to perform a search processing for determining the size of the prediction block (prediction block size) and the size of the transform block (transform block size).

On the other hand, the CU size of the coding block size of the HEVC is variable. Therefore, the search processing needs to be performed to determine the PU and the TU size for each CU size (the block size from 64×64 pixels to 8×8 pixels) which can be taken by the HEVC to acquire a higher coding efficiency in coding of the HEVC. Through this processing, appropriate sizes of respective CU, PU, and TU can be determined.

As described above, a problem arises in that, when the transcoding is performed from the existing coding systems excluding the HEVC to the HEVC, the transcoding becomes larger in a processing load (a calculation amount), by the processing for determining the coding block size, than the convention transcoding, thus increasing the processing time of the transcoding.

The problem, however, arises not only in the HEVC but also in other coding systems whose coding block sizes are variable.

### SUMMARY OF THE INVENTION

The present invention is directed to a coding system transform apparatus and a coding system transform method capable of determining the appropriate size of each block while reducing a processing load required for determining a coding block size used for coding at the time of recoding in transcoding.

According to an aspect of the present invention, a coding system transform apparatus includes a decoding unit configured to decode a first coded stream coded by a first coding system using a first coding parameter to acquire a decoded image, a coding unit configured to code the decoded image acquired by the decoding unit by a second coding system using a second coding parameter, and a parameter determination unit configured to determine the second coding parameter based on the first coding parameter, in which the parameter determination unit includes a first size determination unit which determines the maximum block size of a second coding block size included in the second coding parameter among a plurality of coding block sizes possible in the second coding system to be a block size that is the same as a first coding block size included in the first coding parameter.

Further features of the present invention will become apparent from the following description of exemplary embodiments with reference to the attached drawings.

According to the present invention, it is possible to determine the appropriate size of each block while reducing a processing load for searching a coding block size at the time of recoding in the transcoding.

### BRIEF DESCRIPTION OF THE DRAWINGS

FIG. 1 is a block diagram of a coding system transform apparatus according to a first exemplary embodiment.

FIG. 2 is a flow chart illustrating processing for determining a recoding parameter according to the first exemplary embodiment.

FIGS. 3A and 3B are tables illustrating block sizes determined in the first exemplary embodiment.

FIG. 4 is a diagram illustrating processing for determining a coding parameter using tables in the first exemplary embodiment.

FIGS. 5A, 5B, and 5C are diagrams illustrating prediction modes of the intra prediction of the H.264.

FIG. 6 is a diagram illustrating the prediction modes of the intra prediction of the HEVC.

FIGS. 7A, 7B, and 7C are tables illustrating the intra prediction modes determined in the first exemplary embodiment.

FIGS. 8A, 8B, and 8C are diagrams illustrating split of TU.

FIG. 9 is a block diagram of a coding system transform apparatus according to a second exemplary embodiment.

FIG. 10 is a diagram illustrating a correspondence between a coded_block_pattern (CBP) and a block in a YUV420 format.

FIGS. 11A, 11B, and 11C are tables illustrating values of the CBP.

FIG. 12 is a flow chart illustrating processing for determining a recoding parameter according to the second exemplary embodiment.

FIG. 13 is a flow chart illustrating TU size determination processing based on the CBP according to the second exemplary embodiment.

FIGS. 14A and 14B are tables illustrating block sizes determined for the case of the intra prediction according to the second exemplary embodiment.

FIGS. 15A and 15B are tables illustrating block sizes determined for the case of the inter prediction according to the second exemplary embodiment.

FIG. 16 is a block diagram illustrating an example of a hardware configuration of a computer applicable to the coding system transform apparatus according to a third exemplary embodiment.

### DESCRIPTION OF THE EMBODIMENTS

Exemplary embodiments of the present invention are described below with reference to the attached drawings. Configurations illustrated in the following exemplary embodiments are merely an example and the present invention is not limited to the illustrated configurations.

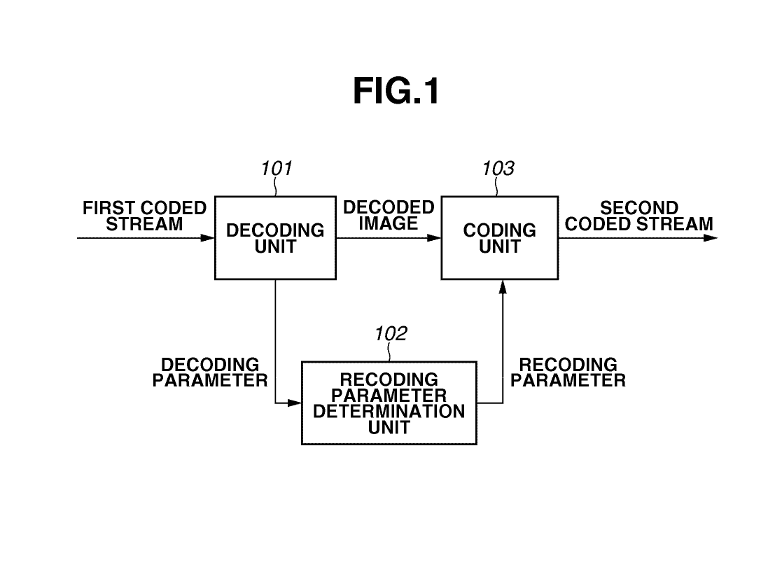

FIG. 1 is a block diagram illustrating a coding system transform apparatus according to a first exemplary embodiment. The coding system transform apparatus according to the present exemplary embodiment includes a decoding unit 101, a recoding parameter determination unit 102 (a size determination unit), and a coding unit 103.

The decoding unit 101 decodes an input coded stream coded by a first coding system (hereinafter referred to as a first coded stream). The decoding unit 101 transmits a decoding parameter used at the time of decoding the first coded stream to the recoding parameter determination unit 102, and transmits a decoded image acquired by decoding the first coded stream to the coding unit 103. The recoding parameter determination unit 102 determines a parameter used at the time of recoding the decoded image by a second coding system (hereinafter referred to as a recoding parameter) based on the decoding parameter input from the decoding unit 101, and transmits the determined recoding parameter to the coding unit 103. The coding unit 103 codes the decoded image input from the decoding unit 101 by a second coding system based on the recoding parameter input from the recoding parameter determination unit 102 and outputs a second coded stream.

Further, each unit will be described. For the sake of simplifying the description, the first coded stream is taken as a stream coded by the H.264 format, and the second coded stream is taken as a stream coded by the HEVC format.

The decoding unit 101 receives the first coded stream and decodes the input first coded stream. The decoding unit 101 transmits the following information as the decoding parameter from among pieces of information acquired at the time of decoding the first coding stream to the recoding parameter determination unit 102. More specifically, the decoding unit 101 transmits information related to at least a macro block size (a coding block size), a prediction block size at the time of intra prediction and inter prediction, and transform block size as the decoding parameter to the recoding parameter determination unit 102.

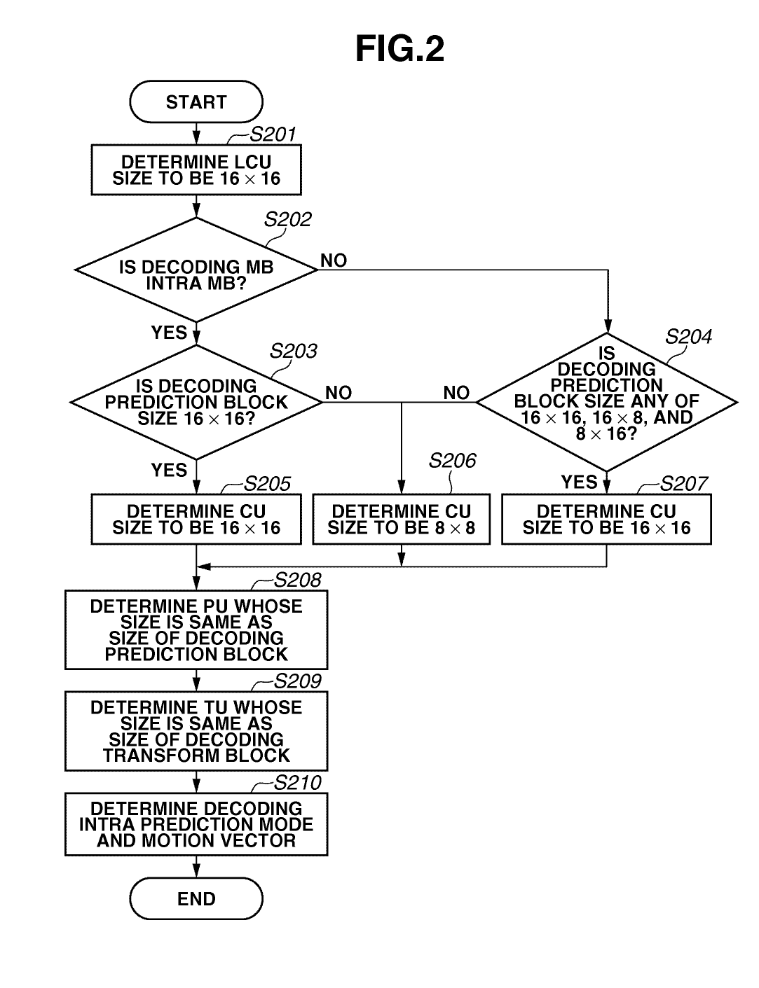

The recoding parameter determination unit 102 is described below. FIG. 2 is a flow chart illustrating processing for determining the recoding parameter in the recoding parameter determination unit 102. A block size of 16×16 written in FIG. 2 is the same in meaning to 16×16 pixels. The same holds true for the subsequent figures. In the subsequent figures, a CU composed of 16×16 pixels, for example, is also represented as 16×16 CU. Similarly, the PU and the TU are also represented as 16×16 PU or 16×16 TU. Furthermore, the size of the CU is represented as CU size and the sizes of the PU and the TU are represented as PU size and TU size, respectively.

The recoding parameter determination unit 102 acquires the decoding parameter from the decoding unit 101, and then starts processing for determining the recoding parameter.

In step S201, the recoding parameter determination unit 102 determines the size of a largest coding unit (LCU), which is a maximum CU size of the HEVC, to be 16×16 pixels which are the same as the size of a macro block of the H.264. In other words, the recoding parameter determination unit 102 limits the CU size at the time of the coding unit 103 coding in the HEVC to 16×16 pixels. The LCU size can be limited by controlling the syntax of log2_min_coding_block_size_minus3 and log2_diff_max_min_coding_block_size in the HEVC, for example.

In step S202, the recoding parameter determination unit 102 determines whether a block to be recoded is an intra macro block or an inter macro block in the first coded stream. The term “intra macro block” refers to a macro block coded by an intra prediction coding, and the term “inter macro block” refers to a macro block coded by an inter prediction coding.

In the H.264, the prediction block size used for the intra prediction is any of 16×16 pixels, 8×8 pixels, and 4×4 pixels. The prediction block size used for the inter prediction is any of 16×16 pixels, 16×8 pixels, 8×16 pixels, 8×8 pixels, 8×4 pixels, 4×8 pixels, and 4×4 pixels. In other words, in the H.264, candidates for selectable prediction block sizes are different between the intra and the inter prediction. For this reason, in step S202, the candidates for selectable prediction block sizes can be determined by determining whether a block to be recoded is the intra macro block or the inter macro block in the first coded stream.

If the recoding parameter determination unit 102 determines that the block to be recoded is the intra macro block (YES in step S202), then in step S203, the recoding parameter determination unit 102 determines whether the intra prediction block size of the block to be recoded is 16×16 pixels. The term “intra prediction block size” refers to the prediction block size used for the intra prediction in the block to be recoded.

If the recoding parameter determination unit 102 determines that the intra prediction block size is 16×16 pixels (YES in step S203), then in step S205, the recoding parameter determination unit 102 determines the CU size to be 16×16 pixels. If the recoding parameter determination unit 102 determines that the intra prediction block size of the block to be recoded is not 16×16 pixels (NO in step S203), then in step S206, the recoding parameter determination unit 102 determines the CU size to be 8×8 pixels.

The CU size at the time of recoding can be determined through steps S203, S205, and S206 based on the intra prediction block size of the block to be recoded. Furthermore, the recoding parameter determination unit 102 can determine the CU size at the time of recoding to be equal to or smaller than the LCU size (16×16 pixels) determined in step S201 through steps S203, S205, and S206.

If the recoding parameter determination unit 102 determines that the block to be recoded is the inter macro block (NO in step S202), the recoding parameter determination unit 102 confirms the prediction block size of inter prediction of the block to be recoded. In other words, in this case (NO in step S202), in step S204, the recoding parameter determination unit 102 determines whether the prediction block size of inter prediction of the block to be recoded is any of 16×16 pixels, 16×8 pixels, and 8×16 pixels. The term “inter prediction block size” refers to the prediction block size used for the inter prediction in the block to be recoded.

If the prediction block size of inter prediction of the block to be recoded is any of 16×16 pixels, 16×8 pixels, and 8×16 pixels (YES in step S204), then in step S207, the recoding parameter determination unit 102 determines the CU size to be 16×16 pixels. If the prediction block size of inter prediction of the block to be recoded is not any of the above sizes (NO in step S204), then in step S206, the recoding parameter determination unit 102 determines the CU size to be 8×8 pixels.

The CU size at the time of recoding can be determined through steps S204, S206, and S207 based on the inter prediction block size of the block to be recoded.

In the H.264, the intra prediction block size is any of 16×16 pixels, 8×8 pixels, and 4×4 pixels. In other words, a square block is used for the intra prediction block. On the other hand, in the H.264, the inter prediction block size is any of 16×16 pixels, 16×8 pixels, 8×16 pixels, 8×8 pixels, 8×4 pixels, 4×8 pixels, and 4×4 pixels. In other words, not only a square block but also a rectangle block is used for the inter prediction block. For this reason, in step S204, the recoding parameter determination unit 102 determines the CU size at the time of recoding in consideration that the inter prediction block is any of square and rectangle.

The recoding parameter determination unit 102 can determine the determined CU size at the time of recoding to be equal to or smaller than the LCU size (16×16 pixels) determined in step S201 through steps S204, S206, and S207.

After the CU size is determined, in step S208, the recoding parameter determination unit 102 determines the size equal to the prediction block size of the intra, and the inter prediction in the first coded stream as the PU size of the block to be recoded. In step S209, the recoding parameter determination unit 102 determines the size equal to the transform block size in the first coded stream as the TU size of the block to be recoded.

The present exemplary embodiment is not limited to the processing in step S209 in relation to the determination of the PU size in a case where the block to be recoded is the inter macro block, and existing various methods may be applied. The method for determining the inter prediction block size which is used for the coding transformed from the MPEG-2 to the H. 264 may be applied also in a case where the inter prediction block size is determined in the present exemplary embodiment.

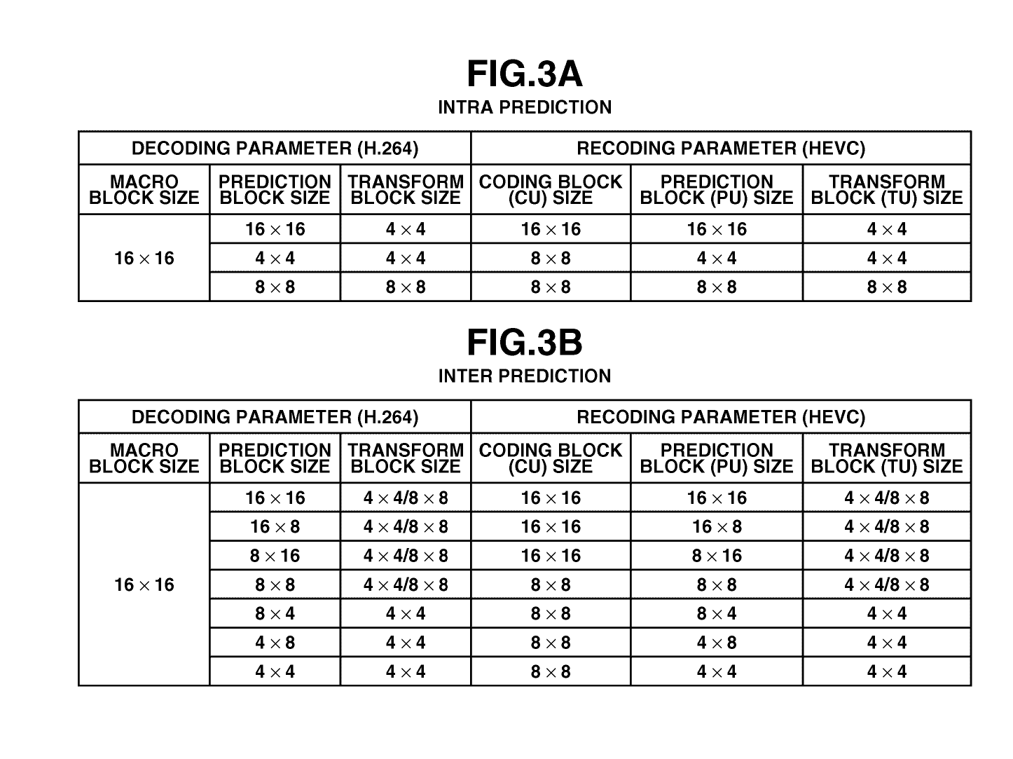

FIGS. 3A and 3B illustrate recoding parameters (the CU, PU, and TU sizes) determined in the above processing (steps S201 to S209 in FIG. 2) and used for decoding.

FIG. 3A is a table exemplifying the CU, PU, and TU sizes determined by the processing described with reference to FIG. 2 in a case where the block to be recoded is the intra macro block.

If the intra prediction block size of the first coded stream is 16×16 pixels, the CU size is taken as 16×16 pixels and the PU size is taken as 16×16 pixels. If the intra prediction block size of the first coded stream is 4×4 pixels, the CU size is taken as 8×8 pixels, and the PU size is taken as 4×4 pixels. If the intra prediction block size of the first coded stream is 8×8 pixels, the CU size is taken as 8×8 pixels, and the PU size is taken as 8×8 pixels.

If the transform block size of the first coded stream is 4×4 pixels, the TU size is taken as 4×4 pixels. If the transform block size of the first coded stream is 8×8 pixels, the TU size is taken as 8×8 pixels.

FIG. 3B is a table exemplifying the CU, PU, and TU sizes determined by the processing described with reference to FIG. 2 in a case where the block to be recoded is the inter macro block.

If the inter prediction block size of the first coded stream is any of 16×16 pixels, 16×8 pixels, and 8×16 pixels, the CU size is taken as 16×16 pixels, and the PU size is taken to be the same as that of the first coded stream. If the inter prediction block size of the first coded stream is any of 8×8 pixels, 8×4 pixels, 4×8 pixels, and 4×4 pixels, the CU size is taken as 8×8 pixels and the PU size is taken to be the same as that of the first coded stream.

If the transform block size of the first coded stream is 4×4 pixels, the TU size is taken as 4×4 pixels, and if the transform block size of the first coded stream is 8×8 pixels, the TU size is taken as 8×8 pixels.

A correspondence relationship illustrated in FIGS. 3A and 3B is stored in an array in a table format, and the recoding parameter determination unit 102 may determine the recoding parameter with reference to the table based on the decoding parameters.

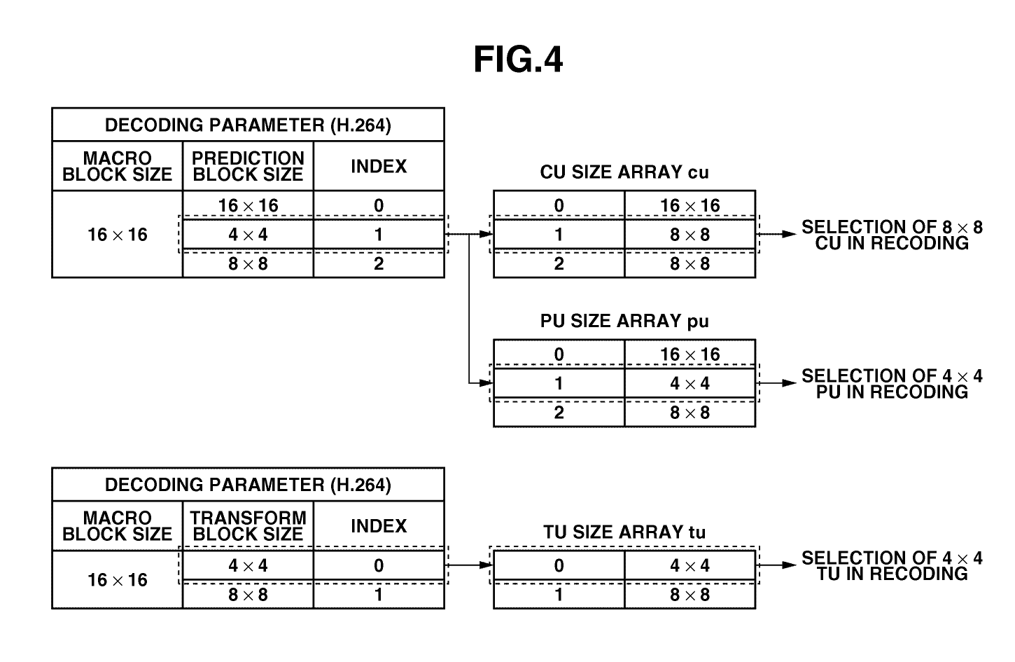

FIG. 4 illustrates processing which refers to the recoding parameters stored in the array in the table format with various block sizes at the time of decoding the first coded stream as an index in a case where the block to be recoded is the intra macro block.

If the prediction block size at the time of decoding the first coded stream is 4×4 pixels, a reference is made to arrays CU[1] and PU[1] storing the CU and the PU size using an associated index 1. The CU[1] and PU[1] store information indicating 8×8 pixels and 4×4 pixels, respectively, so that the CU and the PU size at the time of recoding are determined to be 8×8 pixels and 4×4 pixels, respectively.

If the transform block size at the time of decoding the first coded stream is 4×4 pixels, a reference is made to an array TU[0] storing the TU size using an associated index 0. The TU[0] stores information indicating 4×4 pixels, so that the TU size at the time of recoding is determined to be 4×4 pixels.

Also for the case of other predictions and transform block sizes, the CU, PU, and TU sizes can be determined similarly.

Also for the case where the block to be recoded is the inter macro block, processing can be performed similarly to the processing in FIG. 4.

As described above, the recoding parameter is stored in the table format to allow the recoding parameter to be determined at a higher speed than a case where the flow illustrated in FIG. 2 is realized by the branch processing of software.

Returning to FIG. 2, and the processing flow in step S210 and subsequent steps in the recoding parameter determination unit 102 will be described.

The recoding parameter determination unit 102 determines the CU, PU, and TU sizes used for recoding (in steps S201 to S209) and then performs processing in step S210. In other words, in step S210, the recoding parameter determination unit 102 determines an intra prediction mode and a motion vector in the block to be recoded based on the intra prediction mode and the motion vector at the time of decoding the first coded stream. Then, the processing is ended. The term intra prediction mode refers to a prediction mode in the intra prediction.

For example, in step S210, the intra prediction mode similar to the intra prediction mode at the time of decoding the first coded stream may be taken as the intra prediction mode in the block to be recoded. Also, in step S210, the motion vector similar to the motion vector at the time of decoding the first coded stream may be taken as the motion vector in the block to be recoded. The term “the motion vector close to the motion vector at the time of decoding the first coded stream” refers to a motion vector which is analogous to (similar to) the motion vector at the time of decoding the first coded stream in a temporal and spatial position of the macro block to which a reference is made in the inter prediction. Existing various determination methods may be applied to a method for determining the motion vector.

A method is for determining the intra prediction mode by the recoding parameter determination unit 102 in step S210 illustrated in FIG. 2 will be described below.

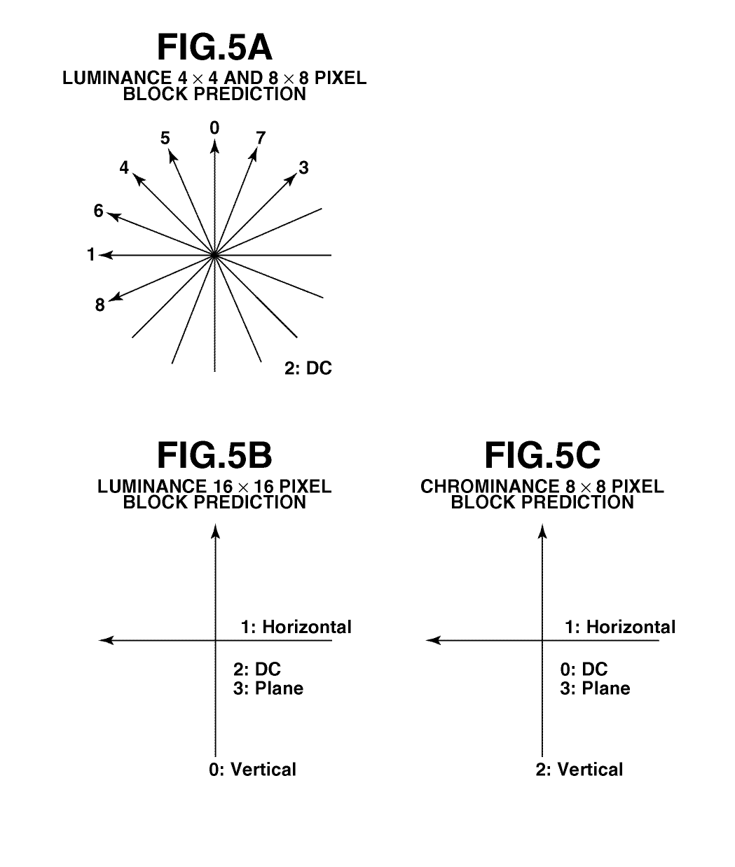

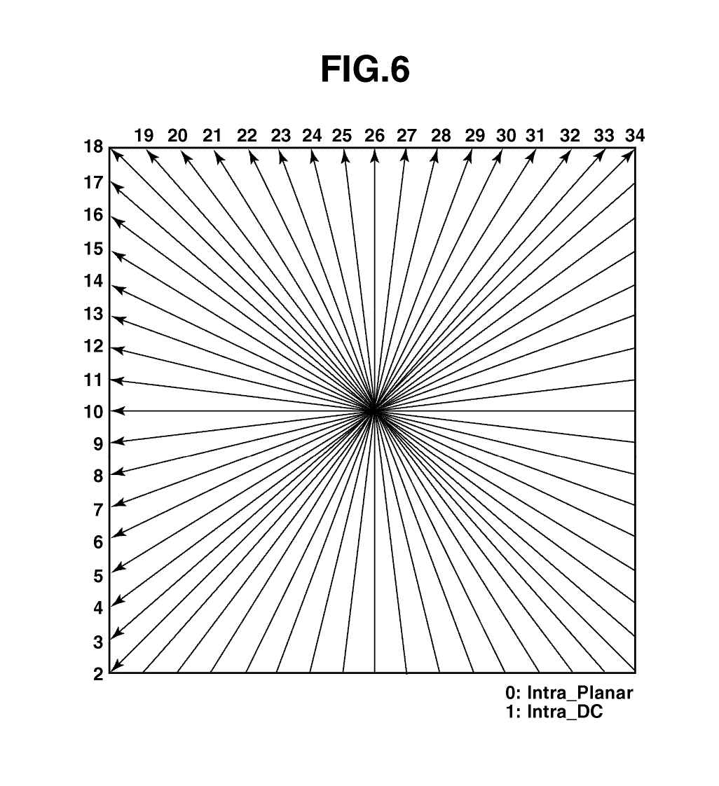

FIGS. 5A, 5B, and 5C illustrate the intra prediction mode of the H.264, and FIG. 6 illustrates the intra prediction mode of the HEVC.

As illustrated in FIG. 5A, the H.264 defines nine modes in the intra prediction of blocks of 4×4 pixels and 8×8 pixels of a luminance sample (hereinafter referred to as luminance). The following four modes are defined in the intra prediction of blocks of 16×16 pixels of luminance and in the intra prediction of blocks of 8×8 pixels of a chrominance sample (hereinafter referred to as chrominance). More specifically, four modes of horizontal prediction (horizontal), vertical prediction (vertical), mean value prediction (DC), and plane prediction (plane) are defined in 16×16 pixel block prediction of luminance of the H.264 and 8×8 pixel block prediction of chrominance. Hereinafter, 4×4 pixel block of luminance are represented by luminance 4×4 pixel block (independently of the number of pixels), for example. Furthermore, 8×8 pixel block of chrominance is represented by chrominance 8×8 block (independently of the number of pixels).

On the other hand, the intra prediction of luminance of the HEVC is performed for the PU sizes of 4×4 pixels, 8×8 pixels, 16×16 pixels, 32×32 pixels, and 64×64 pixels. As illustrated in FIG. 6, 35 intra prediction modes of luminance are defined for each PU size. Incidentally, the intra prediction mode of chrominance can be selected from five modes based on the intra prediction modes of luminance. For this reason, searching all of the intra prediction modes at the time of recoding leads to an increase in a processing load. For this reason, in the present exemplary embodiment, only the HEVC intra prediction mode similar to the H.264 intra prediction mode is selected.

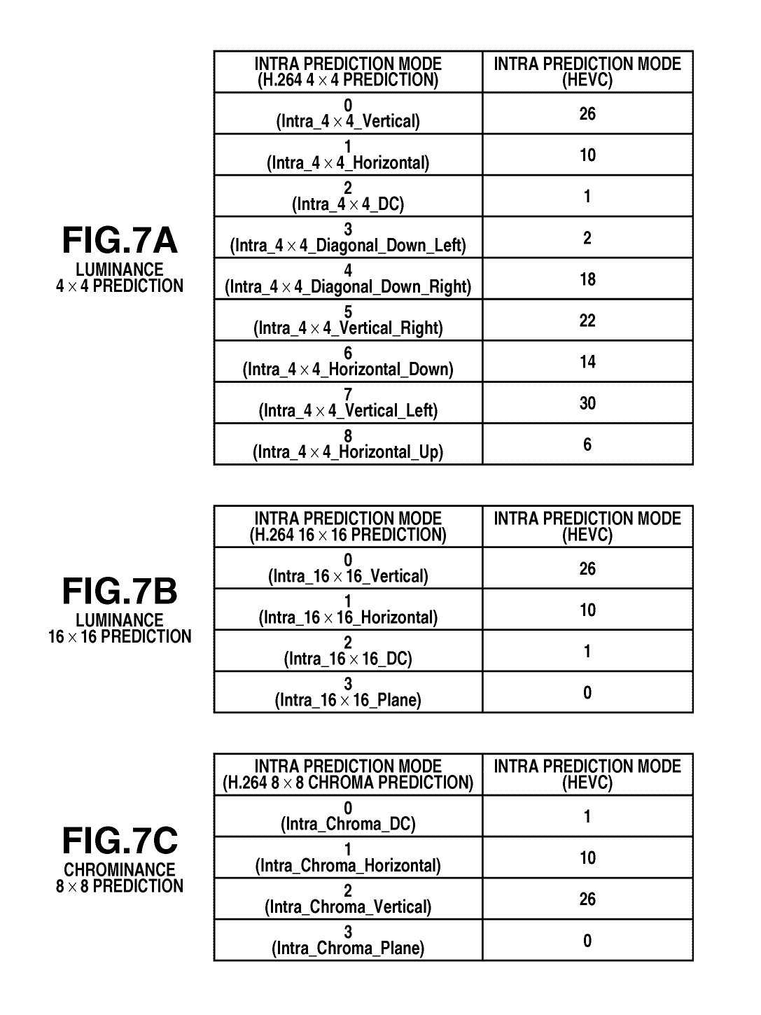

FIGS. 7A, 7B, and 7C illustrate the HEVC intra prediction mode corresponding to the H.264 intra prediction mode.

FIG. 7A illustrates the intra prediction mode of the HEVC (a second coded stream) corresponding to the intra prediction of luminance 4×4 pixel block and luminance 8×8 pixel block of the H.264 (a first coded stream). If the intra prediction mode of the H.264 is 0:Intra_{—}4×4_vertical, 26:Intra_Angular is associated with the intra prediction mode of the H.264 as the intra prediction mode of the HEVC. If the intra prediction mode of the H.264 is 6:Intra_{—}4×4_Horizontal_Down, 14:Intra_Angular which is more similar among the intra prediction modes is associated with the intra prediction mode of the H.264. Also for other intra prediction modes, equivalent modes or modes similar in a prediction direction are associated one-to-one therewith.

FIGS. 7B and 7C illustrate the intra prediction mode of the HEVC corresponding to the intra prediction modes of luminance 16×16 pixel block of the H.264 and chrominance 8×8 pixel block of the H.264.

The recoding parameter determination unit 102 illustrated in FIG. 1 transmits information about the CU, PU, and TU sizes, the intra prediction mode, and the motion vector which are thus determined to the coding unit 103 as the recoding parameter.

The coding unit 103 codes the decoded image output from the decoding unit with the HEVC based on the recoding parameter transmitted from the recoding parameter determination unit 102. In the present exemplary embodiment, the coding unit 103 subjects the decoded image output from the decoding unit 101 to the intra prediction using the prediction block size included in the recoding parameter output from the recoding parameter determination unit 102 to calculate a prediction residual. The coding unit 103 further subjects the prediction residual to the orthogonal transform and quantization using the transform block size included in the recoding parameter output from the recoding parameter determination unit 102. The coding unit 103 subjects the orthogonally transformed and quantized prediction residual to entropy coding using the coding block size included in the recoding parameter output from the recoding parameter determination unit 102.

The term “prediction block size” refers to a block size used when the coding unit 103 subjects the decoded image output from the decoding unit 101 to the intra prediction (prediction processing) and calculates the prediction residual. The term “transform block size” refers to a block size used when the coding unit 103 subjects the prediction residual to the orthogonal transform and the quantization. The term “coding block size” refers to a block size used when the coding unit 103 subjects the orthogonally transformed and quantized prediction residual to entropy coding.

As described above, in the present exemplary embodiment, the LCU size in the HEVC is limited to 16×16 pixels in accordance with the macro block size in the H.264 at the time of recoding from the H.264 to the HEVC. This allows decreasing a processing load required for searching the CU size.

In the present exemplary embodiment, the CU size at the time of recoding is limited to 16×16 pixels in accordance with the macro block size in the H.264. In the conventional technique, on the other hand, the CU size at the time of recoding uses 64×64 pixels and 32×32 pixels as candidates for search. For this reason, in the conventional technique, the decoding processing of the H.264 needs to be finished by four macro blocks or two macro blocks in the horizontal direction to start searching 64×64 pixels and 32×32 pixels which are candidates for the CU size at the time of recoding. In the present exemplary embodiment, the CU size at the time of recoding is limited to 16×16 pixels, so that the decoding processing of the H.264 only needs to be finished by one macro block to start searching the CU size at the time of recoding. For this reason, the present exemplary embodiment allows reducing delay in start of searching the CU size at the time of recoding.

Also in the present exemplary embodiment, the CU and PU sizes at the time of recoding to the HEVC are determined based on the prediction block size of the H.264. In the conventional technique, on the other hand, candidates for all of the CU and PU sizes need to be searched to determine the CU and PU sizes at the time of recoding. For example, there is a method in which a prediction error is determined for each of all possible combinations between the CU and PU sizes, and a combination is selected between the CU and PU sizes which is the smallest in the prediction error. In other words, the present exemplary embodiment has no need for searching all combinations between the CU and PU sizes and allows determining the appropriate CU and PU sizes while further decreasing a processing load of the search processing for determining the CU and PU sizes.

In the present exemplary embodiment, the transform block size of the H.264 is taken as the TU size at the time of recoding to the HEVC. In the conventional technique, on the other hand, there is a method in which the transform and the coding processing are performed by all possible TU sizes and the TU size in which the amount of generated code is the smallest is selected. In other words, the present exemplary embodiment has no need for searching all possible TU sizes and allows determining the appropriate TU size while further decreasing a processing load of the search processing for determining the TU size.

As described above, in the present exemplary embodiment, the intra prediction mode at the time of recoding to the HEVC is taken as the mode equivalent to the intra prediction mode of H.264 or the mode similar in the prediction direction of H.264. For this reason, the present exemplary embodiment can cause pixels to which a reference is made (reference pixels) to generate the prediction image at the time of recoding in the HEVC to approach the reference pixels at the time of decoding the first coded stream coded by the H.264. Therefore, the prediction image generated at the time of recoding in the HEVC can be caused to approach the prediction image generated at the time of coding in the H.264. Therefore, an error value of the prediction error acquired by prediction at the time of recoding in the HEVC can be caused to approach an error value of the prediction error acquired at the time of coding in the H.264. For example, if a large number of zeros are included in the prediction error acquired by decoding a predetermined area of the first coded stream, a large number of zeros are also included in the prediction error acquired by prediction at the time of recoding the same area in the HEVC. An amount of codes acquired by coding the prediction error acquired at the time of recoding in the HEVC does not make much difference from an amount of codes acquired by coding the prediction error acquired at the time of coding in the H.264. As a result, in the present exemplary embodiment, a coding efficiency can be maintained (an increase in an amount of codes can be suppressed).

Because the intra prediction mode at the time of recoding in the HEVC is taken as the mode equivalent to the intra prediction mode of H.264 or the mode similar in the prediction direction of H.264, there is no need for searching all intra prediction modes which can be used in the HEVC. This allows significantly reducing the processing load for searching the prediction mode at the time of determining recoding parameters.

The present invention is not limited thereto, and the functions of the recoding parameter determination unit 102 may be provided inside the decoding unit 101 or the coding unit 103. The coding unit 103 may use only a part of the recoding parameters determined by the recoding parameter determination unit 102. For example, only the CU, PU, and TU sizes out of the recoding parameters are used, and the intra prediction mode and the motion vector may be searched by the coding unit 103. The coding unit 103 may separately search the parameters with the recoding parameters determined by the recoding parameter determination unit 102 as a starting point or an initial value at the time of searching the CU, PU, and TU sizes or the intra prediction mode.

The present invention may be applied to any one of the intra and the inter prediction.

In the present exemplary embodiment, the TU size is determined based on the transform block size at the time of decoding the first coded stream, however, the present invention is not limited thereto. The TU size may be determined to be the same CU size. Thereby, the TU size in which frequency components can be most finely remained among the possible TU sizes for the CU size is selected to improve reproducibility of the decoded image in which the second decoded stream is decoded.

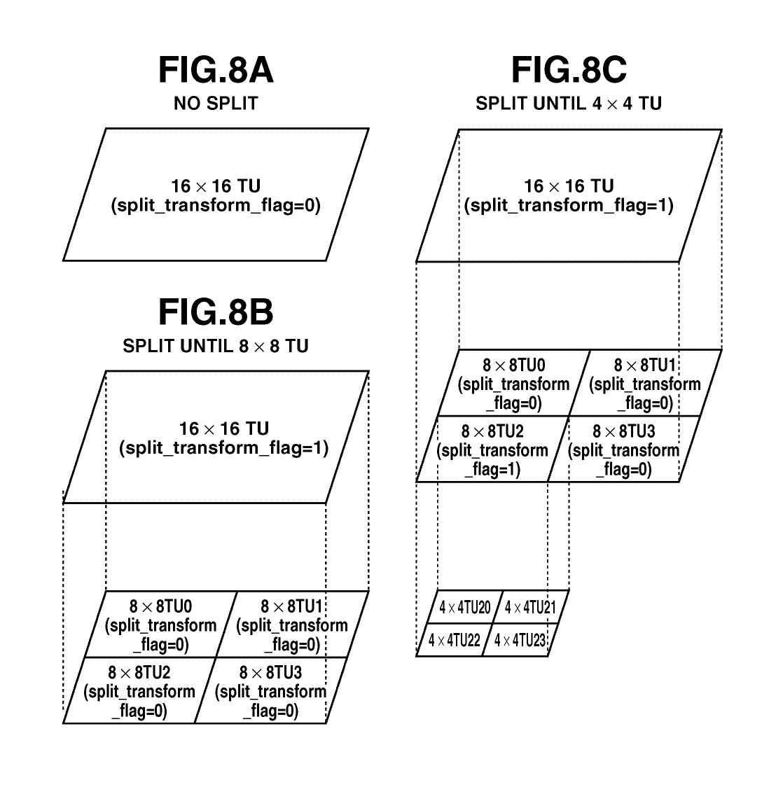

In the HEVC, as illustrated in FIGS. 8A, 8B, and 8C, the TU size is specified using information (split_transform_flag syntax) for splitting the TU size. As illustrated in FIG. 8A, if a 16×16 TU is applied to a 16×16 CU, the split_transform_flag=0 has only to be set to the 16×16 TU. As illustrated in FIG. 8B, if an 8×8 TU is applied, the split_transform_flag=1 has only to be set to the 16×16 TU and the split_transform_flag=0 has only to be set to at least one of an 8×8 TU0 to an 8×8 TU3. As illustrated in FIG. 8C, if a 4×4 TU is applied, the split_transform_flag=1 has only to be set to at least one of the 8×8 TU0 to the 8×8 TU3.

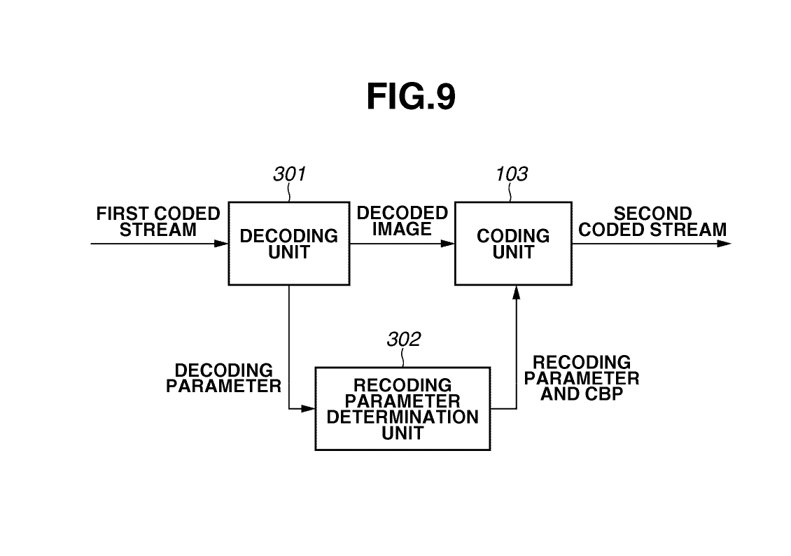

A coding system transform apparatus according to a second exemplary embodiment of the present invention is described below with reference to FIG. 9. In FIG. 9, the components similar to those in the first exemplary embodiment illustrated in FIG. 1 are given the same reference numerals.

Similar to the first exemplary embodiment, for the sake of simplifying description, the first coded stream is taken as a stream coded by the H.264 format and the second coded stream is taken as a stream coded by the HEVC format.

A decoding unit 301 transmits information similar to the information transmitted from the decoding unit 101 according to the first exemplary embodiment as a decoding parameter to a recoding parameter determination unit 302. The decoding unit 301 further transmits information relating to a coded_block_pattern (CBP) to the recoding parameter determination unit 302.

The CBP is information indicating whether a significant coefficient (non 0 coefficient) is included in a predetermined block to be coded. In general, if the significant coefficient is not included in the predetermined block to be coded, it can be determined that the predetermined block to be coded does not need to be coded in the coding processing. The coded stream in the H.264 includes syntax indicating whether a significant coefficient exists in the luminance and chrominance blocks for each macro block excluding the case where the macro block is coded in an I_PCM or in 16×16 pixel intra prediction. There is coded_block_pattern syntax as a syntax indicating whether the significant coefficient exists in the luminance and chrominance blocks.

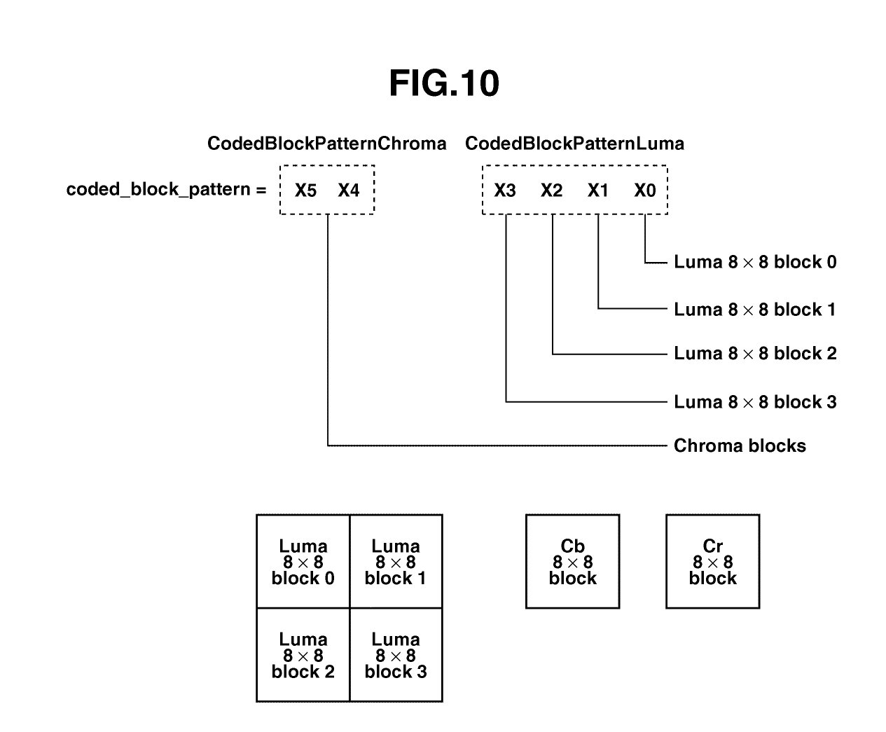

FIG. 10 illustrates a correspondence between the syntax and the macro block in a YUV420 format.

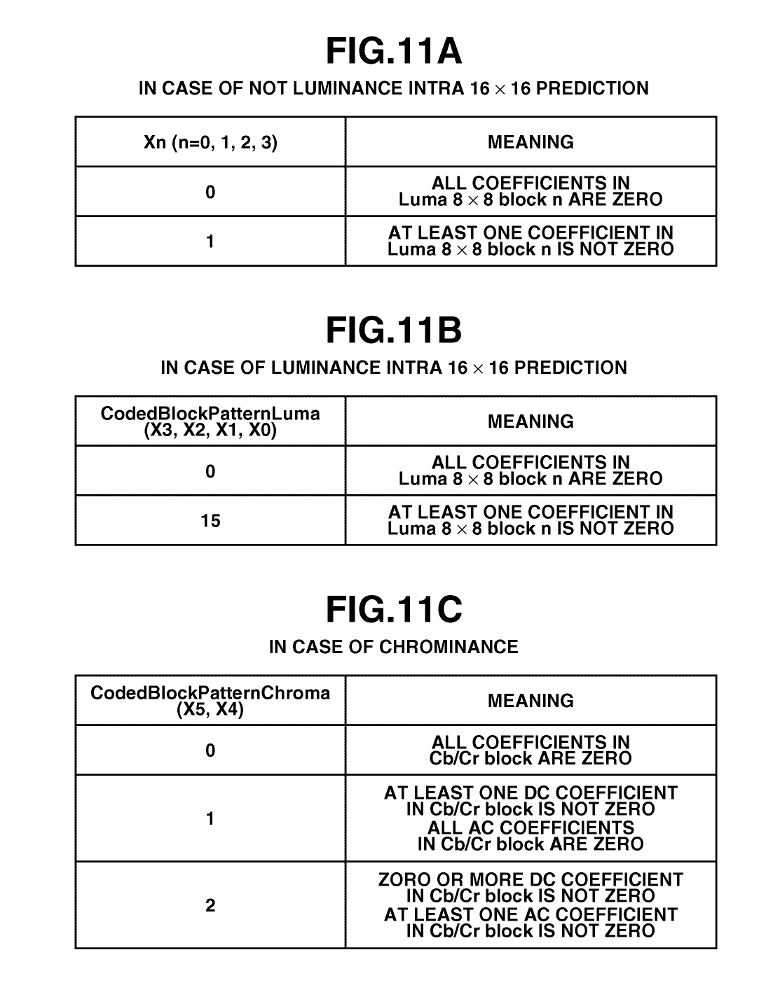

As illustrated in FIG. 10, lower 4 bits of the coded_block_pattern are handled as a CodedBlockPatternLuma variable. Each bit of the lower 4 bits indicates whether the significant coefficient exists in four luminance 8×8 pixel block inside the 16×16 pixels macro block. FIG. 11A illustrates the meaning of values which each bit of the lower 4 bits can take.

FIG. 11A is described below with X0 in FIG. 10 cited as an example. In FIG. 11A, if a value of X0 is zero, the values of all coefficients of four 4×4 pixel blocks inside the luminance 8×8 pixel block 0 (Luma 8×8 block 0) become zero. In FIG. 11A, if a value of X0 is one, the value of at least one coefficient in at least one 4×4 pixel block inside the same block becomes non zero (i.e., other than zero). The same holds true for X1 to X3.

Upper two bits (X5, X4) of coded_block_pattern in FIG. 10 are handled as CodedBlockPatternChroma values and indicate whether the significant coefficient exists in two chrominance (Cb and Cr) 8×8 pixel blocks. FIG. 11C illustrates the meaning of values which each bit of the higher two bits can take.

FIG. 11C is described below with X5 and X4 in FIG. 10 cited as an example. In FIG. 11C, if the values of the variables of the upper two bits (X5, X4) of coded_block_pattern in FIG. 10 are zero, the values of all coefficients inside the chrominance block become zero. If the values of the variables of the upper two bits are one, the values of at least one of DC coefficients in the chrominance block are non zero and the values of all AC coefficients are zero. If the values of the variables of the upper two bits are two, the values of zero or more DC coefficients in the chrominance block are non zero and the values of at least one AC coefficient are non zero.

For the case of the intra prediction with 16×16 pixels, the coded_block_pattern syntax illustrated in FIG. 10 is not included in the coded stream. For this reason, alternatively, a CodedBlockPatternLuma variable and a codedBlockPatternChroma variable are derived from another syntax (mb_type). For the case of the intra prediction with 16×16 pixels, the CodedBlockPatternLuma variable becomes zero or 15. FIG. 11B illustrates the meaning of each value.

FIG. 11B is described below with X3, X2, X1, and X0 in FIG. 10 cited as examples. In FIG. 11B, if the CodedBlockPatternLuma variable is zero, the values of all AC coefficients inside the 16×16 intra macro block (inside the 16 luminance 4×4 pixel blocks) become zero. If the variable is not zero (the CodedBlockPatternLuma variable is 15), the value of at least one coefficient is not zero.

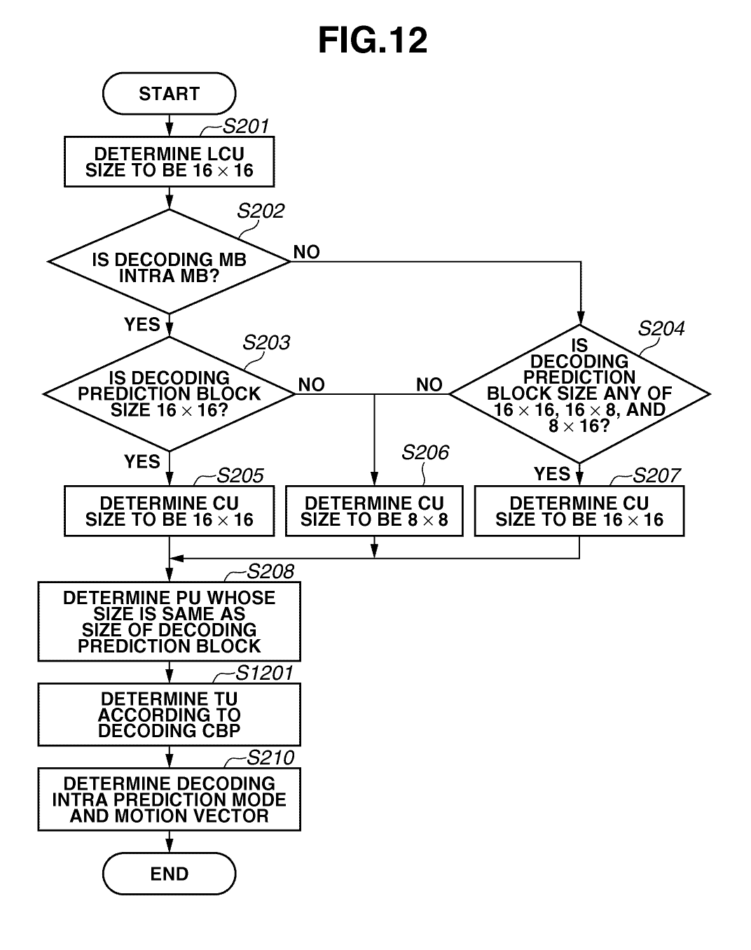

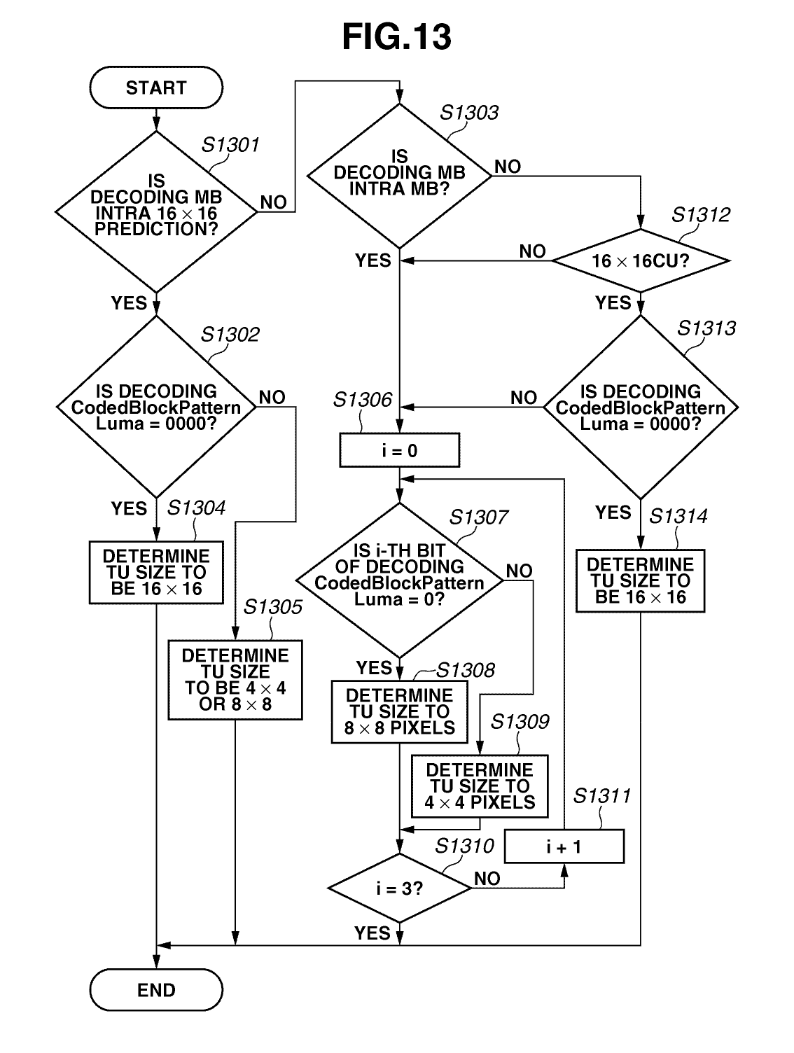

The recoding parameter determination unit 302 determines the recoding parameter according to the flow chart illustrated in FIG. 12 based on the decoding parameter including the CBP acquired from the decoding unit 301. FIGS. 12 to 13 illustrate the processing in which the coding system transform apparatus according to the present exemplary embodiment determines the recoding parameter.

In FIG. 12, the processing similar to that in the first exemplary embodiment is given the same reference numerals. The processing in steps S201 to S208 and S210 is similar to that in the first exemplary embodiment.

In step S1201, the recoding parameter determination unit 302 determines the TU size based on the CBP acquired at the time of decoding the first coded stream. Detailed processing for determining the TU size is illustrated in the flow chart in FIG. 13.

The recoding parameter determination unit 302 acquires the decoding parameter from the decoding unit 301, and then starts processing for determining the recoding parameter.

In step S1301, the recoding parameter determination unit 302 determines whether the prediction block size of the block to be recoded is the intra macro block being 16×16 pixels (hereinafter referred to as 16×16 intra macro block).

If it is determined that the block to be recoded is 16×16 intra macro block (YES in step S1301), then in step S1302, the recoding parameter determination unit 302 determines whether the CodedBlockPatternLuma variable is 0000.

If it is determined that the CodedBlockPatternLuma variable is 0000 (YES in step S1302), then in step S1304, the recoding parameter determination unit 302 determines the TU size to be 16×16 pixels and ends the processing. In this case (YES in step S1302), the block to be recoded is the 16×16 intra macro block and the CodedBlockPatternLuma variable is 0000, so the values of all AC coefficients inside the block to be recoded are estimated to be zero. Therefore a prediction error at the time of decoding the first coded stream is changed in units of 4×4 pixels according to the value of DC coefficients inside the block to be recoded.

In step S1304, the recoding parameter determination unit 302 uses the 16×16 TU for such a prediction error. Because the recoding parameter determination unit 302 selects the TU size based on the block area where the CBP is determined to be zero among the blocks to be recoded, the amount of codes generated at the time of coding the transform coefficient of the block area is not significantly increased.

If it is determined that the CodedBlockPatternLuma variable is not 0000 (NO in step S1302), then in step S1305, the recoding parameter determination unit 302 determines the TU size to be an appropriate size other than 16×16 pixels, and ends the processing. It is possible for the HEVC to use a plurality of the TU sizes together in the CU. For this reason, in step S1305, an appropriate TU size is determined for each 8×8 block in the block to be recoded (any of 4×4 TU or 8×8 TU is used) to allow a coding efficiency to be improved.

If it is determined that the block to be recoded is not 16×16 intra macro block (NO in step S1301), then in step S1303, the recoding parameter determination unit 302 determines whether the block to be recoded is the intra macro block.

If it is determined that the block to be recoded is the intra macro block (YES in step S1303), then in step S1306, the recoding parameter determination unit 302 initializes a loop control variable i (i=0). In this case (YES in step S1303), by the processing in FIG. 12, the block to be recoded is the intra macro block (YES in step S202) and the prediction block size is not 16×16 (NO in step S203). Therefore, in step S206, the recoding parameter determination unit 302 determines the CU size to be 8×8 pixels. For this reason, if it is determined that the block to be recoded is the intra macro block (YES in step S1303), the recoding parameter determination unit 302 determines the CU size to be 8×8 pixels and the TU sizes for each 8×8 CU.

In step S1306, the recoding parameter determination unit 302 initializes the loop control variable i, and, in step S1307, the recoding parameter determination unit 302 determines whether the value in the i-th bit of the CodedBlockPatternLuma variable is zero. If the value in the i-th bit of the variable is zero (YES in S1307), then in S1308, the recoding parameter determination unit 302 determines the TU size of each of the corresponding 8×8 CU to be 8×8 pixels. On the other hand, if the value in the i-th bit of the variable is one (NO in S1307), then in S1309, the recoding parameter determination unit 302 determines the TU size of each of the corresponding 8×8 CU to be 4×4 pixels. Because the similar processing needs to be applied to each of the 8×8 CU inside the block of 16×16 pixels, the recoding parameter determination unit 302 repeats the processing from steps S1307 to S1309 four times via the processing of steps S1310 and S1311. If i is not three (NO in step S1310), then in step S1311, i is incremented and thereafter, the processing in steps S1307 to S1309 is repeated until i reaches three. If i reaches three (YES in step S1310), the processing is ended.

As described above, if the block to be recoded is the intra macro block other than 16×16 intra macro block (the prediction block size is other than 16×16) (YES in step S1303), the CU size is determined to be 8×8 pixels in the processing in FIG. 12. For this reason, the coding efficiency can be improved by using any of 4×4 TU and 8×8 TU (steps S1308 or S1309) for each 8×8 CU corresponding to each bit of the CodedBlockPatternLuma variable.

If it is determined that the block to be recoded is not the intra macro block (NO in step S1303), then in step S1312, the recoding parameter determination unit 302 determines whether the block to be recoded is the 16×16 CU in the processing in FIG. 12.

If the block to be recoded is the 16×16 CU (YES in step S1312), then in step S1313, the recoding parameter determination unit 302 determines whether the CodedBlockPatternLuma variable is 0000. If the CodedBlockPatternLuma variable is 0000 (YES in step S1313), then in step S1314, the recoding parameter determination unit 302 determines the TU size to be 16×16 pixels and ends the processing. In this case (YES in step S1313), the block to be recoded is the inter macro block, the CU size is 16×16 pixels, and the CodedBlockPatternLuma variable is 0000. For this reason, it is estimated that the values of a large number of coefficients inside the block to be recoded are zero. The use of the 16×16 TU (in step S1314) allows reducing split information of the TU size at the time of recoding to the HEVC.

If the block to be recoded is not the 16×16 CU (NO in step S1312) or the CodedBlockPatternLuma variable is not 0000 (NO in step S1313), the processing proceeds to step S1306. In this case (NO in step S1312 or NO in step S1313), as is the case with the intra prediction in which the prediction block size is the size other than the 16×16 pixels (YES in the step S1303), the coding efficiency can be improved. In step S1306, the recoding parameter determination unit 302 initializes a loop control variable i. In steps S1307 to S1311, the recoding parameter determination unit 302 determines the TU size for each block of 8×8 pixels and ends the processing.

Similar to the first exemplary embodiment, the present exemplary embodiment uses the prediction block size, the intra prediction mode, and the motion vector at the time of recoding to the HEVC which are same as those in the H.264 via the processing in steps S201 to S208 and S210 in FIG. 12. Thereby, a trend in the prediction error caused by prediction at the time of recoding to the HEVC is analogous to a trend in the prediction error acquired by decoding the first coded stream (caused by prediction at the time of coding in the H.264). Similarly, a trend of the information as to presence of significant coefficient caused by transformation and quantization in recoding with HEVC is analogous to a trend in those acquired by decoding the first coded stream (caused by transformation and quantization at the time of coding in the H.264). More specifically, the block whose CBP is zero at the time of decoding the first stream coded in the H.264 format includes only zero coefficients also at the time of recoding to the HEVC, or includes a large number of zeros. For this reason, in the present exemplary embodiment, if all coefficient values in the block are zero, the TU size is determined to be equal to or larger than the size of the block. Thereby, if all coefficient values in the block are zero, there is no need for performing the TU size search of the size smaller than that of the block. It is possible to reduce the processing load of the search processing for determining the TU size and determine an appropriate TU size.

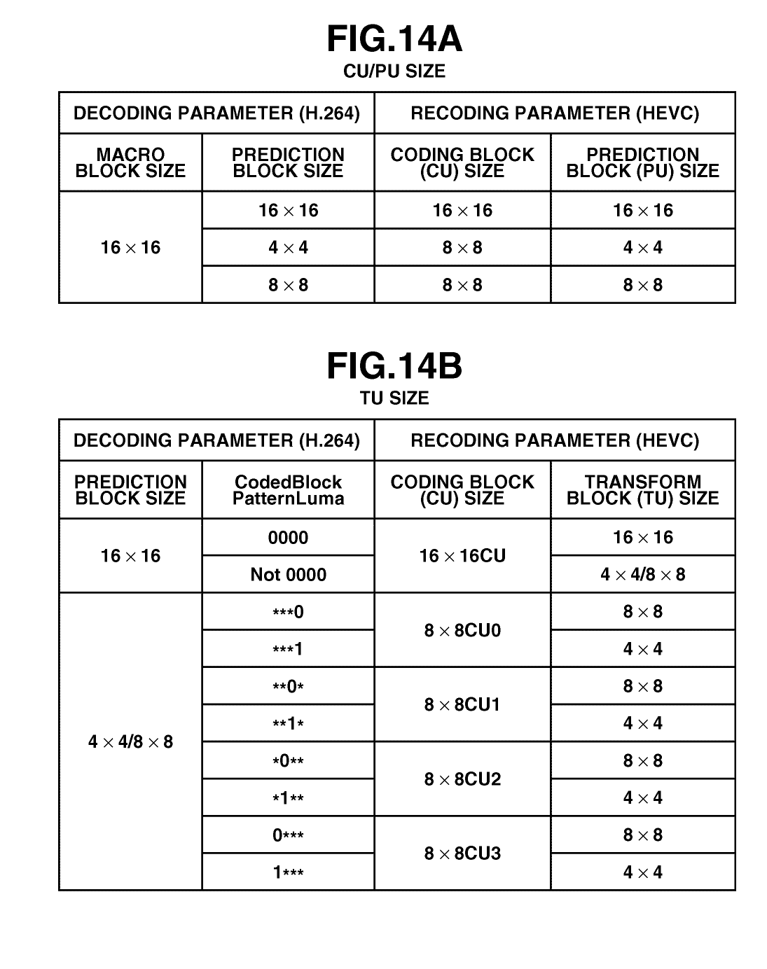

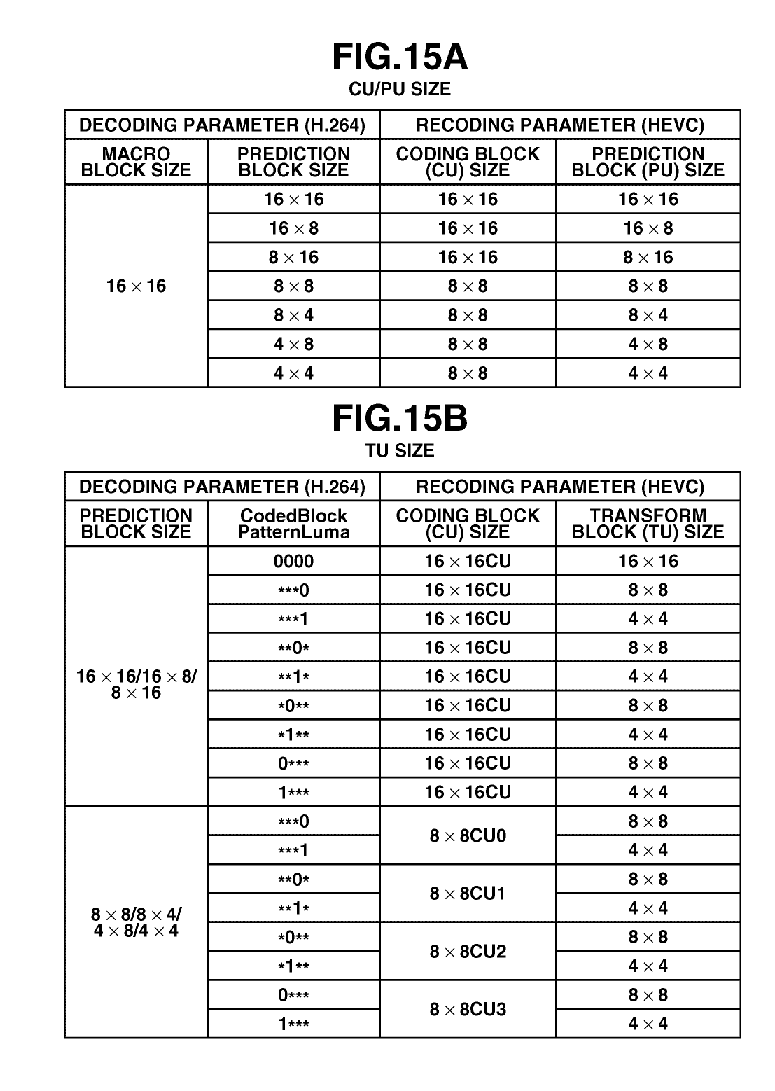

The present invention is neither limited to the above description nor limited to the processing illustrated in FIGS. 12 and 13. For example, the recoding parameter determined from the decoding parameter by a series of processing in FIGS. 12 and 13 may be stored in the recoding parameter determination unit 302 in a table format illustrated in FIGS. 14 and 15. The CU0 to CU3 illustrated in FIGS. 14 and 15 correspond to the Luma 8×8 block 0 to the Luma 8×8 block 3 illustrated in FIG. 10 respectively.

Similar to the first exemplary embodiment, the recoding parameters are stored in the table format to allow the recoding parameters to be determined at a higher speed than the case where the flow illustrated in FIGS. 12 and 13 is realized by the branch processing of software.

Also in the present exemplary embodiment, similar to the first exemplary embodiment, it is possible to reduce the processing load of the search processing for determining the CU and the PU size.

In the present exemplary embodiment, the TU size at the time of recoding to the HEVC is determined based on the CBP at the time of decoding in the H.264 to improve the coding efficiency, allowing information about the split of the TU to be reduced.

The application to the transcoding from the H.264 coded stream to the HEVC coded stream is described above using the first and second exemplary embodiments. It is obvious that the present invention can be applied not only to the above embodiments but also to the transcoding using other coding systems. It is also obvious that the method for determining the recoding parameter illustrated in FIGS. 2, 11, and 12 is merely an example and not limited to the example.

All of the present invention or a part of the processing may be mounted as software.

In the first and second exemplary embodiment, the processing units illustrated in FIGS. 1 and 9 are configured by hardware. However, the processing performed by the processing units illustrated in FIGS. 1 and 9 may be executed by a computer program, according to a third exemplary embodiment.

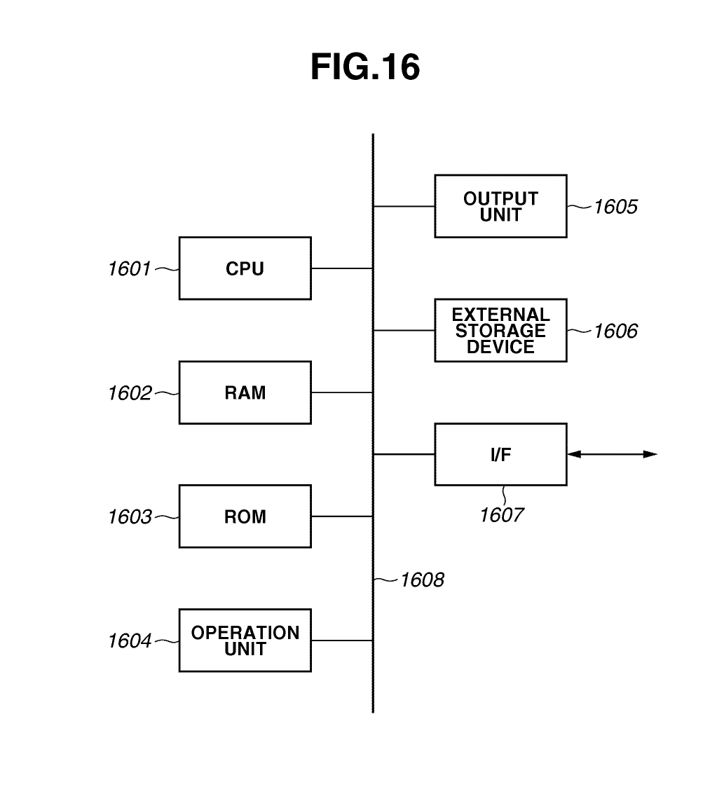

FIG. 16 is a block diagram illustrating an example of a configuration of hardware of a computer executing the processing performed by each processing unit of the coding system transform apparatus according to the first and second exemplary embodiments.

A CPU 1601 controls the entire computer using a computer program and data stored in a RAM 1602 and a ROM 1603 and executes each of the abovementioned processing which is supposedly performed by the coding system transform apparatus according to the first and second exemplary embodiments. In other words, the CPU 1601 functions as each of the processing units illustrated in FIGS. 1 and 9.

The RAM 1602 has an area for temporarily storing computer programs and data loaded from an external storage device 1606 and data acquired from the outside via an interface (I/F) 1607. The RAM 1602 has a work area used when the CPU 1601 executes various types of processing. The RAM 1602 is allocated as a frame memory or can properly provide other various types of areas, for example.

The ROM 1603 stores setting data and a boot program of the computer.

An operation unit 1604 is composed of a keyboard and a mouse. A user of the computer operates the operation unit 1604 to allow various instructions to be input to the CPU 1601.

An output unit 1605 performs control for displaying results processed by the CPU 1601. The output unit 1605 performs control for displaying results processed by the CPU 1601 on a display unit (not illustrated) composed of a liquid crystal display, for example.

The external storage device 1606 is a large capacity information storage device typified by a hard disk drive device. The external storage device 1606 stores an operating system (OS) and computer programs for causing the CPU 1601 to realize the functions of each unit illustrated in FIGS. 1 and 9. The external storage device 1606 may store images to be processed.

The computer programs and the data stored in the external storage device 1606 are loaded to the RAM 1602 if needed according to the control of the CPU 1601 and processed by the CPU 1601.

The I/F 1607 can be connected to a network such as a local area network and the Internet and other apparatuses such as a projection apparatus and a display device, and the computer can acquire and transmit various pieces of information via the I/F 1607.

A bus 1608 connects the above-described units with one another.

For the operation in the above configuration, the CPU 1601 performs control of the operation described in the above flow chart with the CPU 1601 as a center.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment (s) of the present invention, and by a method performed by the computer of the system or apparatus by, for example, reading out and executing the computer executable instructions from the storage medium to perform the functions of one or more of the above-described embodiment (s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-287235, filed Dec. 28, 2012, which is hereby incorporated by reference herein in its entirety.

What is claimed is:

1. A coding system transform apparatus comprising:
a decoding unit configured to decode a first coded stream coded by a first coding system using a first coding parameter to acquire a decoded image;
a coding unit configured to code the decoded image acquired by the decoding unit by a second coding system using a second coding parameter; and
a parameter determination unit configured to determine the second coding parameter based on the first coding parameter;
wherein the parameter determination unit includes a first size determination unit configured to determine a maximum block size of a second coding block size included in the second coding parameter among a plurality of coding block sizes possible in the second coding system to be a block size that is the same as a first coding block size included in the first coding parameter.

2. The coding system transform apparatus according to claim 1,
wherein the second coding parameter includes a second prediction block size for performing a prediction processing on the decoded image, and
wherein the parameter determination unit further includes a second size determination unit configured to determine the second coding block size and the second prediction block size included in the second coding parameter based on a first prediction block size included in the first coding parameter.

3. The coding system transform apparatus according to claim 2, wherein the second size determination unit determines the second prediction block size to be equal in value to the first prediction block size.

4. The coding system transform apparatus according to claim 1,
wherein the second coding parameter includes a second transform block size for performing an orthogonal transform on the decoded image, and
wherein the parameter determination unit further includes a third size determination unit configured to determine the second transform block size included in the second coding parameter based on a first transform block size included in the first coding parameter.

5. The coding system transform apparatus according to claim 4, wherein the third size determination unit determines the second transform block size to be equal in value to the first transform block size.

6. The coding system transform apparatus according to claim 4, wherein the third size determination unit determines the second transform block size based on whether the value of a block to be coded in the first coded stream is zero or not.

7. The coding system transform apparatus according to claim 6, wherein the third size determination unit determines the second transform block size to be equal in value to the size of the block to be coded if the value of the block to be coded is zero.

8. The coding system transform apparatus according to claim 1, wherein the parameter determination unit further determines a second intra prediction mode included in the second parameter based on a first intra prediction mode included in the first coding parameter.

9. The coding system transform apparatus according to claim 1, wherein the parameter determination unit further determines a second motion vector included in the second parameter based on a first motion vector included in the first coding parameter.

10. A coding system transform method comprising:
decoding a first coded stream coded by a first coding system using a first coding parameter to acquire a decoded image;
coding the acquired decoded image by a second coding system using a second coding parameter; and
determining the second coding parameter based on the first coding parameter;
wherein a maximum block size of a second coding block size included in the second coding parameter is determined to be a same block size as a first coding block size included in the first coding parameter.

11. A non-transitory computer-readable storage medium storing a program for causing a computer to execute coding system transforming, the program comprising:
computer-executable instructions that decode a first coded stream coded by a first coding system using a first coding parameter to acquire a decoded image;
computer-executable instructions that code the acquired decoded image by a second coding system using a second coding parameter; and
computer-executable instructions that determine the second coding parameter based on the first coding parameter;
wherein a maximum block size of a second coding block size included in the second coding parameter is determined to be a same block size as a first coding block size included in the first coding parameter.
